(19) United States
(12) Patent Application Publication
(10) Pub. No.: US 2007/0084166 A1
(43) Pub. Date: Apr. 19, 2007

(54) Vacuum cleaner bag

(75) Inventors: Heinz-Friedrich Wattenberg, Vlotho (DE); Bernd Wehage, Porta Westfalica (DE)

Correspondence Address: VENABLE LLP, P.O. BOX 34385, WASHINGTON, DC, 20043-9998, US

(73) Assignee: Wolf GmbH, Vlotho (DE)

(21) Appl. No.: 11/582,384

(22) Filed: Oct. 18, 2006

(30) Foreign Application Priority Data
Oct. 18, 2005 (DE) 20 2005 016 309.0

(51) Int. Cl. B01D 46/00

(52) U.S. Cl. 55/467

(57) ABSTRACT

A vacuum cleaner bag comprises a bottom part including a substantially rectangular base section. A projecting section is disposed proximate to at least one side of the base section. The projecting section, when folded up for the storage position, rests on the base section. Sidewall sections extend peripherally in a direction away from the bottom part to form an inside space.

### CROSS-REFERENCE TO RELATED APPLICATION

This application claims the priority of German Utility Patent Application No. 20 2005 016 309.0, filed Oct. 18, 2005, the subject matter of which is incorporated herein by reference in its entirety.

### BACKGROUND

The present application relates to vacuum cleaners. More specifically, it relates to the vacuum cleaner bags and will be described with particular reference thereto. However, it is to be appreciated that the following may find applications in other systems and apparatuses in which expandable sections and the like are used.

German patent document DE 20 2005 000 918 discloses a dust filter bag, provided with an inlet opening in the front wall, which is surrounded by a flexible filter material consisting of a weldable material. Since the dust filter bag is to have a large inside volume following the expansion, projections are formed on the side onto the sidewalls to permit the volume expansion. The disadvantage of vacuum cleaner bags of this type is that they cannot be adapted easily to the respective shape of the vacuum cleaner chambers. In addition, the seams represent particularly high-stress areas where damage might occur. If the vacuum cleaner bags are folded up, they may not open easily and thus may not reach their full effectiveness.

Also known are vacuum cleaner bags having a massive or block bottom portion in the form of a rectangle, from which a flexible bag extends substantially in a perpendicular direction. Inside folds are provided at opposite-arranged sidewalls of the bag, so that the bag on one hand can be adapted easily to the form of the vacuum cleaner chamber and, on the other hand, can open up easily. However, the inside folds reduce the volume of the vacuum cleaner bag and furthermore increase the costs of producing the vacuum cleaner bags.

The following methods and apparatuses overcome the aforementioned problems and others.

### SUMMARY

A vacuum cleaner bag is disclosed which in an exemplary embodiment includes a bottom part including a substantially rectangular base section. A projecting section is disposed proximate to at least one side of the base section. The projecting section, when folded up for the storage position, rests on the base section. Sidewall sections extend peripherally in a direction away from the bottom part to form an inside space.

### BRIEF DESCRIPTION OF THE DRAWINGS

These and other features and advantages of the application will be further understood from the following detailed description of the preferred embodiments with reference to the accompanying drawings, which show in:

FIG. 1 An exemplary embodiment of a vacuum cleaner bag in the unfolded state; and

FIG. 2 The vacuum cleaner bag according to FIG. 1 in the folded-up state.

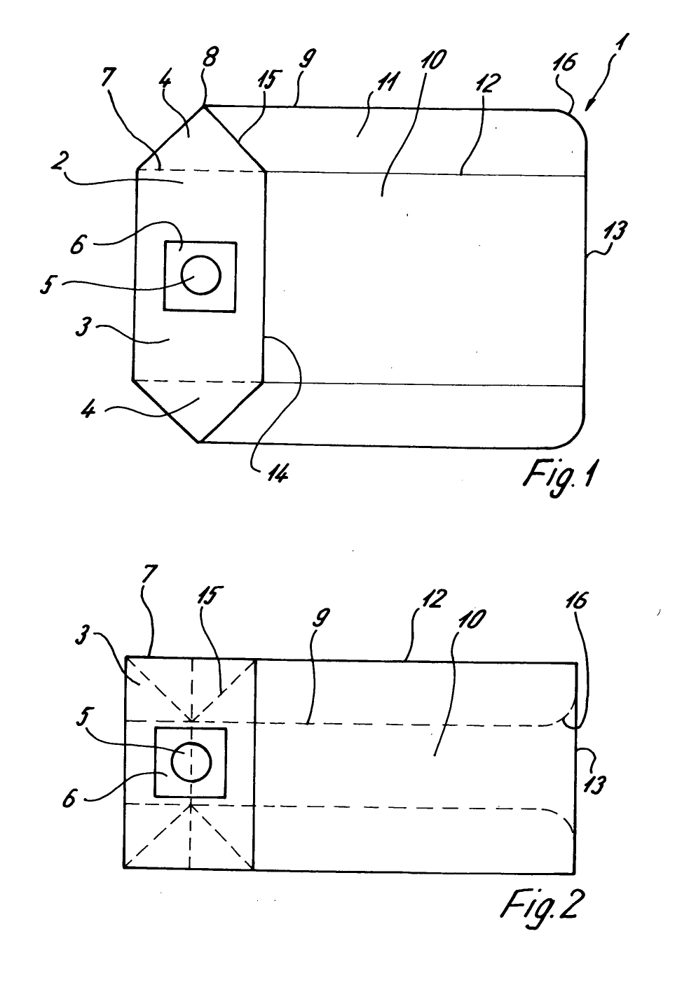

### DETAILED DESCRIPTION OF AN EXEMPLARY EMBODIMENT

A vacuum cleaner bag 1 includes a bottom part 2 including a base section 3. Sidewall sections 10 and 11 extend peripherally in one direction proximate the base section 3 to form a closed inside space. The base section 3, for example, has a substantially rectangular shape. Triangular-shaped projecting sections 4 are formed on shorter opposite sides of the bottom part 2 and are connected via a folding edge 7 to the base section 3. For example, the vacuum cleaner bag is symmetrical to a center plane to permit an easier installation. An inflow opening 5 is provided in the base section 3 of the bottom part 2 for inserting a connecting sleeve of a vacuum cleaner (not shown). The inflow opening 5 is surrounded by a support plate 6.

For example, the vacuum cleaner bag 1 includes one, two, three, four, etc. layers of a nonwoven material. The layers are welded together along joining regions.

As another example, the vacuum cleaner bag 1 can be embodied as a paper bag. The support plate 6 can likewise be produced from cardboard or plastic. The block bottom can be composed of a filter material or a material with higher rigidity.

Each projecting section 4 forms a tip 8 at opposite sides of the bottom part 2. Each tip 8 is adjacent a respective side edge 9 disposed between two folding sections of the sidewall sections 11 on each side of the sidewall 10. Proximate to the bottom part 2, the sidewall sections 11 are embodied at an angle relative to the sidewall section 10 adjacent a longitudinal edge 14 of the base section 3. Each sidewall section 11 is adjacent a side edge 15, disposed between the sidewall section 11 and the projecting section 4. In the unfolded state, the sidewall sections 10 and 11 extend substantially perpendicular to the bottom part 2 with the base section 3 and the projecting sections 4. A side edge 12 is disposed between the sidewall sections 10 and 11 and extends up toward an edge 13, which is arranged on the end of the bag opposite the bottom part 2. The sidewall sections 10 and 11 are joined together along the edge 13, with the aid of a welded or glued seam. A rounded or beveled section 16 is provided at the transition between the side edge 9 and the edge 13 to facilitate the unfolding of the vacuum cleaner bag 1 and to prevent any dead space in the corner.

FIG. 2 shows the vacuum cleaner bag 1 in the folded-up state. The side edge 9 is arranged to fit inside the opposite-positioned sidewall sections 10. The projecting sections 4, proximate the shorter sides of the base section 3, are folded inward and rest flat on the base section 3. As illustrated, the bottom part 2 includes three sections: the folded-in projecting sections 4 on the opposite-arranged sides and the support plate 6 with the inflow opening 5 in the center. Dashed lines indicate the folding edges 9 and 15.

In the folded state, the vacuum cleaner bag 1 has a compact design and can be stored and transported easily. However, the projecting sections 4 can be unfolded easily for a use or operation position to provide the vacuum cleaner bag 1 with a large inside volume for dust storage. In addition, the form of the vacuum cleaner bag 1 can be adapted easily to different geometries as for example a cube-shaped chamber inside a vacuum cleaner since the sidewalls extend in one direction from the bottom, preferably at a substantially right angle.

In one embodiment, the bottom part 2 with the support plate 3 and the projecting sections 4 are fabricated from a material with higher rigidity than the sidewall sections 10 and 11 for a stabler assembly. In addition, assembly aids and guide elements can be provided on the bottom part 2. The vacuum cleaner bag 1 can furthermore be produced uniformly of the same type of material.

In the illustrated exemplary embodiment, the projecting sections 4 are triangular in shape. Of course, it is contemplated to vary the geometry of the projecting sections 4. For example, the projecting sections 4 can have rounded geometry, a trapezoid geometry and/or can be provided with a rounded tip 8.

It will be understood that the above description is susceptible to various modifications, changes and adaptations, and the same are intended to be comprehended within the meaning and range of equivalents of the appended claims.

What is claimed is:

1. A vacuum cleaner bag, comprising:
a bottom part including:
a substantially rectangular base section, and
a projecting section disposed proximate to at least one side of the base section, which projecting section, when folded up for the storage position, rests on the base section; and
sidewall sections extending peripherally in a direction away from the bottom part to form an inside space.

2. The vacuum cleaner bag according to claim 1, wherein the projecting section includes:
projecting sections each disposed proximate to a respective one of opposite sides of the base section.

3. The vacuum cleaner bag according to claim 1, wherein the projecting section has a substantially triangular shape.

4. The vacuum cleaner bag according to claim 1, wherein the sidewall sections include first and second folding sidewall sections that come together at a side edge, and the projecting section presents a tip that adjoins the side edge.

5. The vacuum cleaner bag according to claim 4, wherein the side edge has:
a folded-in storage position to fit inside the sidewall sections, and
a use position in which the side edges project outward of the sidewall sections.

6. The vacuum cleaner bag according to claim 4, wherein the sidewall sections are joined in a joining area at an end of the bag opposite the bottom part to form an edge, and further including:
an area of transition between the edge and the side edge between the first and second folding sidewall sections, which transition area is one of rounded or beveled.

7. The vacuum cleaner bag according to claim 6, wherein the sidewall sections include:
one or several layers of nonwoven material that are welded together at least along the joining area.

8. The vacuum cleaner bag according to claim 1, further including:
an inflow opening disposed in one of (1) the base section of the bottom part or (2) one of the sidewall sections.

9. The vacuum cleaner bag according to claim 8, further including:
a support plate attached to the base section and surrounding the inflow opening.

10. The vacuum cleaner bag according to claim 1, wherein the sidewall sections are connected to the bottom part and are joined to each other on an end of the bag opposite the bottom part to form an inside space.

11. The vacuum cleaner bag according to claim 1, wherein the bottom part includes:
a material having a higher rigidity than a material from which the sidewall sections are fabricated.
